(19) United States
(12) Patent Application Publication
(10) Pub. No.: US 2015/0243953 A1
(43) Pub. Date: Aug. 27, 2015

(54) SECONDARY BATTERY

(71) Applicant: Samsung SDI Co., Ltd., Yongin-si (KR)

(72) Inventors: Hong-Jeong KIM, Yongin-si (KR); Jong-Ki LEE, Yongin-si (KR); Kyu-Nam JOO, Yongin-si (KR); Kyun LIM, Yongin-si (KR)

(21) Appl. No.: 14/629,304

(22) Filed: Feb. 23, 2015

(30) Foreign Application Priority Data
Feb. 26, 2014 (KR) 10-2014-0022436

(51) Int. Cl. H01M 2/16; H01M 2/02; H01M 10/0585

(52) U.S. Cl. CPC H01M 2/1686; H01M 2/162; H01M 2/1653; H01M 2/1646; H01M 10/0585; H01M 2/0207; H01M 2/1673; H01M 2220/30; H01M 10/0525

(57) ABSTRACT

A secondary battery includes a first electrode assembly configured to include a first positive electrode plate, a first negative electrode plate, and a first separator interposed between the first positive electrode plate and the first negative electrode plate, a second electrode assembly configured to include a second positive electrode plate, a second negative electrode plate, and a second separator interposed between the second positive electrode plate and the second negative electrode plate, the second separator having a porosity greater than that of the first separator, the first electrode assembly having high capacity, as compared with second electrode assembly, and the second electrode assembly having high power, as compared with the first electrode assembly, and a case configured to accommodate the first and second electrode assemblies therein.

### CROSS-REFERENCE TO RELATED APPLICATION

The present application claims priority under 35 U.S.C. §119 to Korean Patent Application No. 10-2014-0022436, filed on Feb. 26, 2014, in the Korean Intellectual Property Office, and entitled: “Secondary Battery,” which is incorporated by reference herein in its entirety.

### BACKGROUND

1. Field

Embodiments relate to a secondary battery.

2. Description of the Related Art

Secondary batteries are widely used as power sources of portable devices and may be reversibly charged/discharged plural times. Thus, the reuse of the secondary batteries is possible. Thus, the secondary batteries can be efficiently used. The shapes of the secondary batteries used can be freely changed depending on external electronic devices in which the secondary batteries are employed. The secondary batteries can effectively accumulate energy as compared with their volume and mass. Thus, the secondary batteries are frequently used as power sources of portable electronic devices.

### SUMMARY

Embodiments are directed to a secondary battery, including a first electrode assembly configured to include a first positive electrode plate, a first negative electrode plate, and a first separator interposed between the first positive electrode plate and the first negative electrode plate, a second electrode assembly configured to include a second positive electrode plate, a second negative electrode plate, and a second separator interposed between the second positive electrode plate and the second negative electrode plate, the second separator having a porosity greater than that of the first separator, the first electrode assembly having high capacity, as compared with second electrode assembly, and the second electrode assembly having high power, as compared with the first electrode assembly, and a case configured to accommodate the first and second electrode assemblies therein.

The porosity of the second separator may be 40% or more.

The second separator may include polyurethane (PO) or a non-woven fiber mat.

The first separator may have a multi-layered structure.

The first separator may have a two-layer structure of polyethylene (PE)/polypropylene (PP).

The first separator may have a three-layer structure of PP/PE/PP or PE/PP/PE.

The first separator may include a coating layer positioned on at least one surface thereof.

The coating layer may include heat-resistant ceramic.

The coating layer may include a polymer resin.

The first separator may have a tensile strength in a length direction thereof of 1500 kgf/cm² or more, and said tensile strength may be greater than the tensile strength of the second separator in a length direction of the second separator.

The first separator may have a tensile strength in a width direction thereof of 1000 kgf/cm² or more, and said tensile strength may be greater than the tensile strength of the second separator in a width direction of the second separator.

The first separator may have a perforation strength of 550 gf or more, and said perforation strength may be greater than the perforation strength of the second separator.

The first separator may have a contraction ratio of 5% or less when the first separator is exposed at 120° C. for one hour, and said contraction ratio may be less than the contraction ratio of the second separator when the second separator is exposed at 120° C. for one hour.

The second separator may have a ventilation rate such that 100 ml of air passes through the second separator in 300 seconds or less.

The first separator may have a ventilation rate such that 100 ml of air passes through the first separator in 500 seconds or less, and the ventilation rate of the first separator may be less than that of the second separator.

The first and second electrode assemblies may be connected in parallel to each other in the battery.

The first and second electrode assemblies may be accommodated in the case as separate windings.

Embodiments are also directed to a battery, including a sealed housing having first and second electrochemical cells therein, the first and second electrochemical cells being electrically connected in parallel and being impregnated with a same electrolyte, the first electrochemical cell having a discharge capacity in mAh that is greater than that of the second electrochemical cell when measured at a same C-rate, the first electrochemical cell including a first electrode, a second electrode, and a first separator, the first separator being between and in contact with the first and second electrodes, and the second electrochemical cell including a third electrode, a fourth electrode, and a second separator, the second separator being between and in contact with the third and fourth electrodes, the second separator having a porosity that is greater than that of the first separator.

### BRIEF DESCRIPTION OF THE DRAWINGS

Features will become apparent to those of skill in the art by describing in detail exemplary embodiments with reference to the attached drawings in which:

FIG. 1 illustrates a perspective view of a secondary battery according to an example embodiment.

FIG. 2 illustrates an exploded perspective view of the secondary battery shown in FIG. 1.

FIG. 3 illustrates an exploded perspective view of a first electrode assembly shown in FIG. 1.

FIG. 4 illustrates a sectional view of the first electrode assembly shown in FIG. 3.

FIGS. 5 to 7 illustrate sectional views showing modifications of a first separator shown in FIG. 4.

FIG. 8 illustrates an exploded perspective view of the second electrode assembly of the secondary battery shown in FIG. 1.

FIG. 9 illustrates a sectional view of the second electrode assembly shown in FIG. 8.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween.

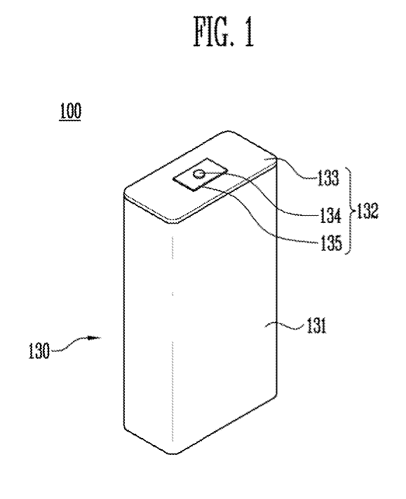

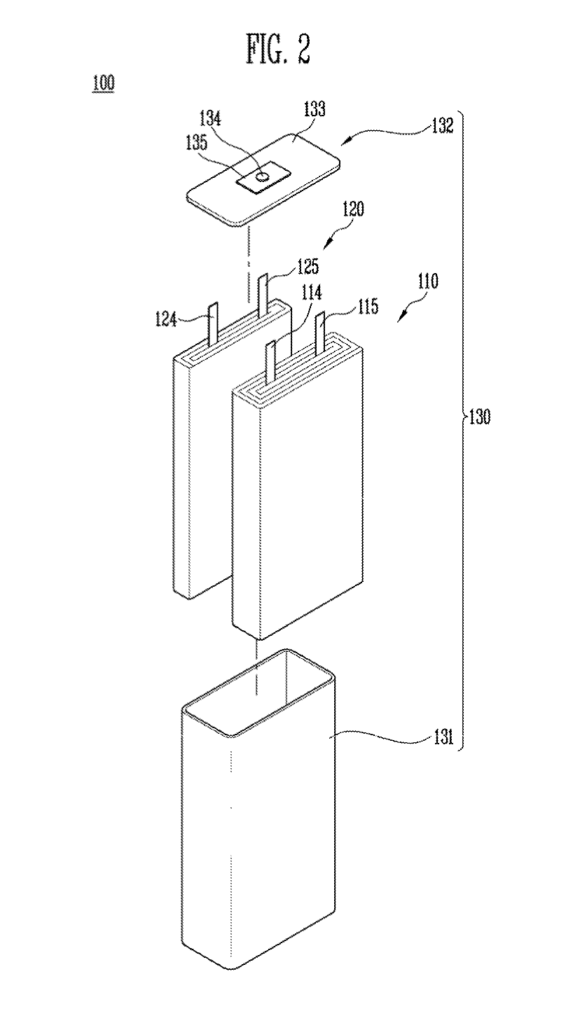

FIG. 1 illustrates a perspective view of a secondary battery 100 according to an example embodiment. FIG. 2 illustrates an exploded perspective view of the secondary battery 100 shown in FIG. 1.

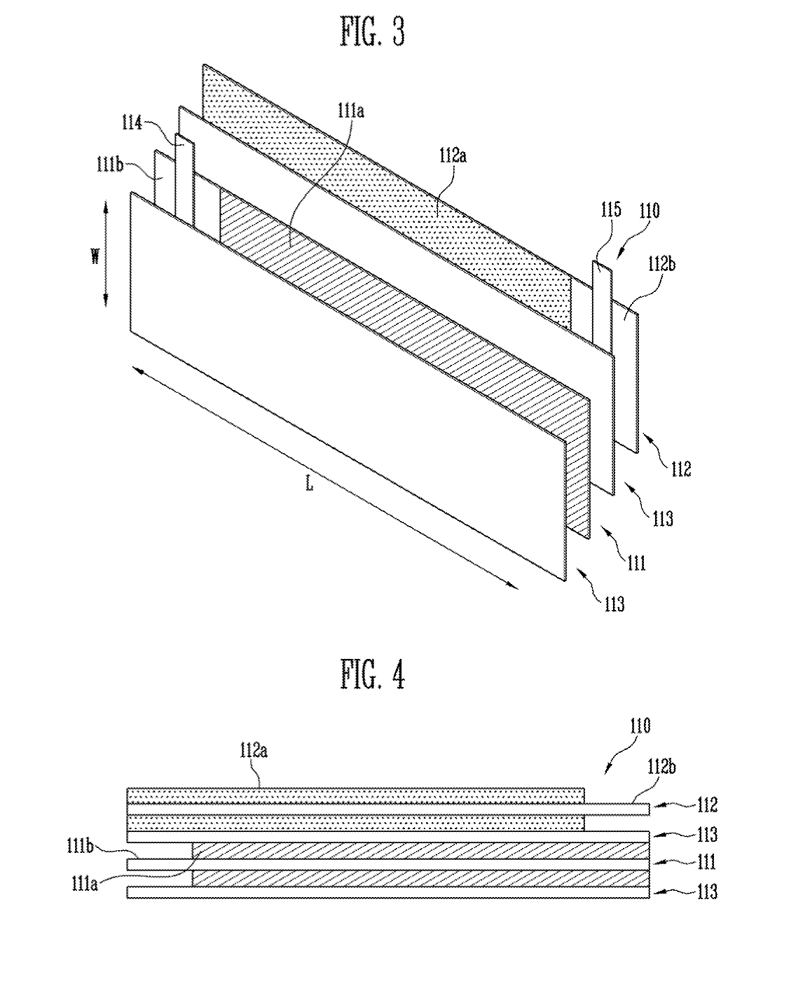

As shown in FIGS. 1 and 2, the secondary battery 100 according to the present example embodiment includes a first electrode assembly 110, a second electrode assembly 120, and a case 130. The second electrode assembly 120 may have low capacity and high power, as compared with the first electrode assembly 110. A second separator 123 (see FIG. 8) of the second electrode assembly 120 may have a porosity greater than that of a first separator 113 (see FIG. 3) of the first electrode assembly 110.

Generally, when a secondary battery is used as a power source of an electronic device such as a smart phone, the state of current required in the secondary battery is changed depending on characteristics and use patterns of the electronic device, but the expectation for the lifespan and use time of the secondary battery is always high. The electronic device has different powers and use capacities, which are respectively required at its operating and waiting times. In case of an ordinary secondary battery, the secondary battery has only one of high capacity or high power.

The use environment of the electronic device may generally include a base load that is a state in which the electronic device consumes low current, and a peak load that is a state in which the electronic device suddenly consumes high current. For example, the peak load is a state in which a high power is required for a short period of time. In an actual product, the peak load when a transmission call is made using a GSM cellular phone is most representative (very short high-power pulse at the level of millisecond), and an AP burst phenomenon (middle-power pulse at the level of sub-second) that power instantaneously increases when a game or the like is driven in a notebook computer, tablet PC or the like may be given as an example of the peak load. In this case, when a secondary battery having high capacity is used as a power source of an electronic device having a large change in load, it is difficult to flexibly deal with a change from the base load to the peak load. As such, the degradation of the secondary battery may be accelerated, and therefore, the lifespan and use time of the secondary battery may be reduced. Since a secondary battery having excellent power characteristics ordinarily has low capacity, the use time of an electronic device may be shortened when such a secondary battery is employed as a power source of the electronic device. Therefore, according to the present example embodiment, the first electrode assembly 110 is implemented with high capacity, as compared with the second electrode assembly 120, and the second electrode assembly 120 is implemented with high power, as compared with the first electrode assembly 110.

In the present example embodiment, the second separator 123 of the second electrode assembly 120 has a porosity greater than that of the first separator 113 of the first electrode assembly 110. Thus, high-capacity and high-power may be implemented in the secondary battery 100. In the present example embodiment, the first electrode assembly 110 is implemented with high capacity and the second electrode assembly 120 is implemented with high power. Thus, it may be possible to flexibly provide for an electronic device having a large change in load, using the second electrode assembly 120, and an increase in usage time, using the first electrode assembly 110. For example, the second electrode assembly 120 may quickly generate high current in a state in which the electronic device is in a peak load, and thus the secondary battery may not damaged, which may improve the lifespan of the secondary battery.

The case 130 is a member which accommodates the first and second electrode assemblies therein. The case 130 may include, for example, a main body 131 of which one surface is opened to accommodate the first electrode assembly 110, the second electrode assembly 120 and an electrolyte, and a cap assembly 132 configured to seal the main body 131. The cap assembly 132 may include a cap plate 133 formed in a shape corresponding to the opened surface of the main body 131, a negative electrode pin 134 provided in the cap plate 133, and a gasket 135 configured to insulate between the negative electrode pin 134 and the cap plate 133. A first positive electrode tab 114 of the first electrode assembly 110 and a second positive electrode tab 124 of the second electrode assembly 120 are electrically connected to the cap plate 133 or the main body 131, and a first negative electrode tab 115 of the first electrode assembly 110 and a second negative electrode tab 125 of the second electrode assembly 120 are electrically connected to the negative electrode pin 134, to supply power to the outside. Although it has been described in the present example embodiment that the secondary battery 100 is a square-type secondary battery, the secondary battery may be, for example, a pouch-type secondary batter, a cylinder-type secondary battery, etc.

The first and second electrode assemblies 110 and 120 accommodated in the case 130 may be separately wound to be formed in different jelly-roll shapes from each other. The first and second electrode assemblies 110 and 120 may share the electrolyte with each other. In this embodiment, the first electrode assembly with high capacity and the second electrode assembly 120 with high power are accommodated in the one case 130 and share the electrolyte with each other, so that it is possible to decrease the size of the secondary battery and to omit a separate voltage control element, etc. In the first and second electrode assemblies 110 and 120, the first and second positive electrode tabs 114 and 124 may be connected in parallel to each other, and the first and second negative electrode tabs 115 and 125 may be connected in parallel to each other. In another implementation, the first and second electrode assemblies 110 and 120 may be wound together.

FIG. 3 illustrates an exploded perspective view of the first electrode assembly 110 shown in FIG. 1. FIG. 4 illustrates a sectional view of the first electrode assembly 110 shown in FIG. 3. The first electrode assembly 110 of the secondary battery 100 according to the present example embodiment will be described with reference to FIGS. 3 and 4.

As shown in FIGS. 3 and 4, the first electrode assembly 110 according to the present example embodiment may include a first positive electrode plate 111, a first negative electrode plate 112 and a first separator 113 interposed between the first positive electrode plate 111 and the first negative electrode plate 112. Relative to the second electrode assembly 120, the first electrode assembly 110 may be implemented with high capacity and the amount of the active material in the first electrode assembly 110 may be large.

Here, the first positive electrode plate 111 may include a first positive electrode active material coating portion 111a where a first positive electrode active material is coated on a first positive electrode base material, and a first positive electrode non-coating portion 111b where the first positive electrode active material is not coated so that the first positive electrode base material is exposed.

In this example embodiment, the first positive electrode base material is a material having high conductivity, and may be a suitable material that does not cause a chemical change. For example, the first positive electrode base material may include aluminum, nickel, titanium, sintered carbon, etc.

The first positive electrode active material may include a lithium compound that is a layered compound including lithium. The first positive electrode active material may further include a conductive agent for improving conductivity, and a binder for improving the bonding force between the lithium compound and the first positive electrode base material. The first positive electrode active material may be formed by mixing the lithium compound, the conductive agent, and the binder with a solvent to prepare the mixture in the form of slurry, and then coating the first positive electrode active material in the form of slurry on the first positive electrode base material. For example, the solvent may include N-methyl-2-pyrrolidone (NMP), and the lithium compound may include LiCoOₓ, LiMnOₓ, LiNiOₓ (here, x is a natural number), etc. The conductive agent may include, for example, carbon black or acetyl black, and the binder may include, for example, polyvinylidene fluoride.

The first negative electrode plate 112 may include a first negative electrode active material coating portion 112a where a first negative electrode active material is coated on a first negative electrode base material, and a first negative electrode non-coating portion 112b where the first negative electrode active material is not coated so that the first negative electrode base material is exposed.

In the present example embodiment, the first negative electrode base material is a conductive metal plate, and may include, for example, copper, stainless steel, aluminum, nickel, etc. The first negative electrode active material may include a carbon compound.

The first negative electrode active material may further include a binder for improving the bonding force between the carbon compound and the first negative electrode base material, and the like. The first negative active material may be formed by mixing the carbon compound, the binder, and the like with a solvent to prepare the mixture in the form of slurry, and then coating the first negative electrode active material in the form of slurry on the first negative electrode base material. For example, the solvent may include water, the carbon compound may include graphite, and the binder may include styrene-butadiene rubber, etc.

The first separator 113 is used to prevent the first positive electrode plate 111 and the first negative electrode plate 112 from being directly contacted with each other, and may be made of a porous insulator so that ions or the electrolyte can move between the first positive electrode plate 111 and the first negative electrode plate 112. The separator 113 may include, for example, two sheets of separators to be interposed between the first positive and negative electrode plates 111 and 112 of the first electrode assembly 110, which are wound. The first electrode assembly 110 may be formed by stacking the first positive electrode plate 111, the first negative electrode plate 112, and the first separator 113.

The electrolyte enables ions such as lithium ions to move between the first positive electrode plate 111 and the first negative electrode plate 112, and may include a lithium salt or additive that acts as a supply source of lithium ions in the secondary battery.

The electrolyte may use a non-aqueous organic solvent. The non-aqueous organic solvent acts as a medium through which ions participating in the electrochemical reaction of the battery can move. The non-aqueous organic solvent may include one or more of a carbonate-based solvent, an ester-based solvent, an ether-based solvent, a ketone-based solvent, an alcohol-based solvent, an aprotic solvent, etc. The carbonate-based solvent may include, for example, a chain carbonate compound such as dimethyl carbonate (DMC), diethyl carbonate (DEC), dipropyl carbonate (DPC), methylpropyl carbonate (MPC), ethylpropyl carbonate (EPC), methylethyl carbonate (MEC) or ethylmethyl carbonate (EMC), an annular carbonate compound such as ethylene carbonate (EC), propylene carbonate (PC) or butylene carbonate (BC), etc. The ester-based solvent may include, for example, methyl acetate, ethyl acetate, n-propyl acetate, dimethyl acetate, methyl propionate, ethyl propionate, decanolide, valerolactone, mevalonolactone, caprolactone, etc. The ether-based solvent may include, for example, dibutyl ether, tetraglyme, diglyme, dimethoxyethane, 2-methyltetrahydrofuran, tetrahydrofuran, etc. The ketone-based solvent may include, for example, cyclohexanone and the like, but the present invention is not limited thereto. The alcohol-based solvent may include, for example, ethyl alcohol, isopropyl alcohol, etc. In this case, the non-aqueous organic solvent may be used singularly or in a mixture. When the organic solvent is used in a mixture, the mixture ratio may be appropriately controlled according to a desirable battery performance.

The lithium salt is dissolved in the organic solvent to promote the movement of lithium ions between positive and negative electrodes. The lithium salt may include, for example, LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ+1SO₂)(C_{y}F_{2y}+1SO₂) (here, x and y are natural numbers), LiCl, LiI, LiB(C₂O₄)₂ (lithium bis(oxalato)borate or LiBOB), combinations thereof, etc. The concentration of the lithium salt may range from about 0.1 to 2.0 M. The concentration of the lithium salt may be variously applied according to design specifications of secondary batteries.

The substantial supply source of lithium ions in the first positive electrode plate 111 is the first positive electrode active material coating portion 111a, and the first positive electrode active material coating portion 111a may exchange ions with the first negative electrode active material coating portion 112a opposite thereto.

The first positive electrode tab 114 is electrically connected to the first positive electrode non-coating portion 111b, and the first negative electrode tab 115 is electrically connected to the first negative electrode non-coating portion 112b, so that power generated through the interaction between the first electrode assembly 110 and the electrolyte can be transferred to an outside of the secondary battery.

FIGS. 5 to 7 illustrate sectional views showing modifications of the first separator 113 shown in FIG. 4. Hereinafter, the first separator 113 according to the present example embodiment will be described in detail with reference to FIGS. 5 to 7.

The first electrode assembly 110 is implemented with high capacity as described above. Thus, the amount of the active material is large, and the first electrode assembly 110 may be prone to instability and a large amount of heat may be generated from the first electrode assembly 110. Accordingly, the first separator 113 of the first electrode assembly 110 may include a material or structure having relatively high stability. The first separator 113 of the first electrode assembly 110 according to the present example embodiment may have a multi-layered structure or coating layer, or use a material having high solidity and low contraction ratio in order to improve the stability of the first electrode assembly 110 having a large amount of active material.

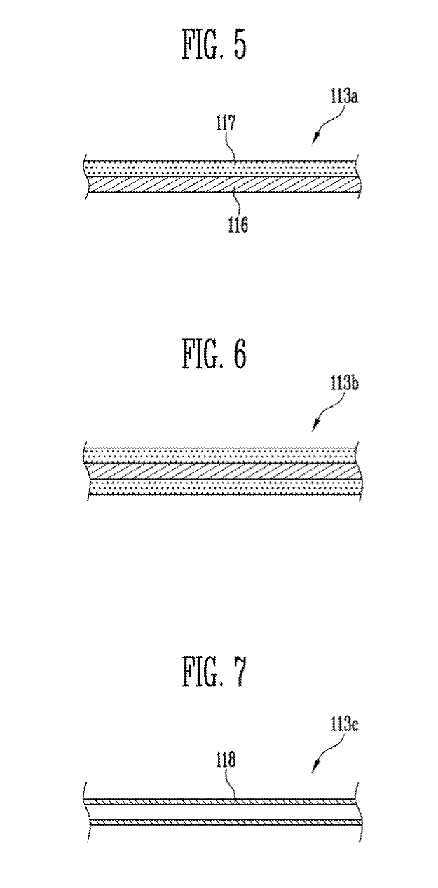

In an example embodiment, as shown in FIG. 5, the first separator 113a may be formed into a two-layer structure of polyethylene (PE)/polypropylene (PP), i.e., in which a first layer 116 is made of PE and a second layer 117 is made of PP or in which the first layer 116 is made of PP and the second layer 117 is made of PE, thereby improving the stability of the first separator 113a. In this case, the first layer 116 may have no connection with which one of the first and second positive electrode plates 111 and 121 the first layer 116 is opposite to. In addition, the first separator 113b, as shown in FIG. 6, is implemented in a three-layer structure of PE/PP/PE or PP/PE/PP, which may further improve the stability of the first separator 113b.

As shown in FIG. 7, a coating layer 118 may be formed on the surface of the first separator 113c. The coating layer 118 may be formed on at least one surface of the first separator 113c. For example, the coating layer 118 may include heat-resistant ceramic or polymer resin, and accordingly, the stability of the first separator 113c can be improved. In this case, the polymer resin may include an adhesive material to be fixed to the electrode plate.

In order to further improve the stability of the first separator 113, the first separator 113 may be implemented using a structure or material having a specific tensile strength (or more). For example, the first separator 113 may have a material or structure where the tensile strength of the first separator 113 in its length direction L is 1500 kgf/cm² or more, or the tensile strength of the first separator 113 in its width direction W is 1000 kgf/cm² or more.

The first separator 113 may be implemented so that the perforation strength of the first separator 113 is 550 gf or more, thereby improving the stability of the first separator 113.

As the contraction ratio increases, the stability decreases. In an implementation, the first separator 113 may have a structure or material where the contraction ratio of the first separator 113 becomes 5% or less when the first separator 113 is exposed at 120° C. for one hour.

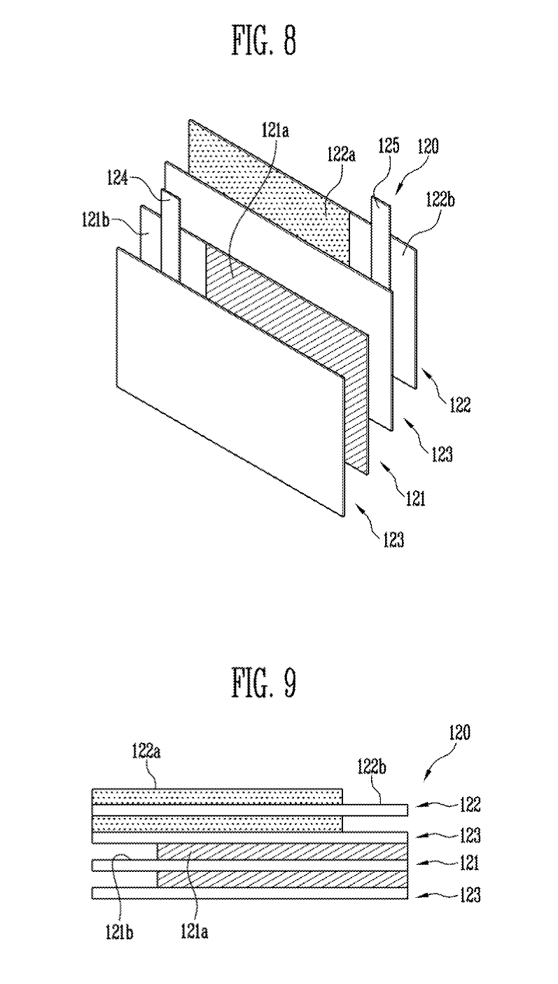

FIG. 8 illustrates an exploded perspective view of the second electrode assembly 120 of the secondary battery 100 shown in FIG. 1. FIG. 9 illustrates a sectional view of the second electrode assembly 120 shown in FIG. 8. The second electrode assembly 120 according to the present example embodiment will be described with reference to FIGS. 8 and 9.

As shown in FIGS. 8 and 9, the second electrode assembly 120 may include a second positive electrode plate 121, a second negative electrode plate 122 and a second separator 123 interposed between the second positive electrode plate 121 and the second negative electrode plate 122.

The second positive electrode plate 121 may include a second positive electrode active material coating portion 121a where a second positive electrode active material is coated on a second positive electrode base material, and a second positive electrode non-coating portion 121b where the second positive electrode active material is not coated so that the second positive electrode base material is exposed. In addition, the second negative electrode plate 122 may include a second negative electrode active material coating portion 122a where a second negative electrode active material is coated on a second negative electrode base material, and a second negative electrode non-coating portion 122b where the second negative electrode active material is not coated so that the second negative electrode base material is exposed. In this case, the second positive electrode tab 124 may be connected to the second positive electrode non-coating portion 121b of the second positive electrode plate 121, and the second negative electrode tab 125 may be connected to the second negative electrode non-coating portion 122b of the second negative electrode plate 122. The second separator 123 is used to prevent the second positive electrode plate 121 and the second negative electrode plate 122 from being directly contacted with each other, and may be interposed between the second positive electrode plate 121 and the second negative electrode plate 122.

The second electrode assembly 120 may be implemented with high power as described above. In order to implement the second electrode assembly 120 with high power, there may be used, for example, a method of decreasing any one or more of the density and/or thickness of the second positive electrode active material coating portion, and/or the loading amount of the second positive electrode active material in the second positive electrode active material coating portion (for example, when the first and second positive electrode active materials are the same).

When the density and thickness of the second positive electrode active material coating portion and the loading amount of the second positive electrode active material in the second positive electrode active material coating portion are decreased, the capacity of the secondary battery may also be decreased. However, the first electrode assembly 110 is implemented with high capacity, decreasing the significance of lessened capacity of the second electrode assembly 120.

Implementing the first electrode assembly 120 with high power may also include, for example, using different active materials for the first and second positive electrode active materials, etc.

In addition to allowing the active materials to be different from each other, allowing the first and second separators to be different from each other may be considered as the method of implementing the second electrode assembly 120 with high power. For example, the second electrode assembly 120 is implemented with high power, and hence the separator 123 may be configured to have a high pore density, i.e., high porosity, as compared with the first separator 113. For example, the porosity of the second separator 123 may be sufficiently increased to 40% or more, so that the movement of ions can be smoothly made, and be decreased to about 25% or more to be smaller than that of the first separator 113, thereby promoting the stability of the second separator 123.

In terms of materials, polyurethane (PO) or non-woven that is relatively highly porous may be used as the second separator 123. However, the material of the second separator 123 is not limited thereto, and a polyolefin-based material such as polypropylene or polyethylene may be used. In this case, the second separator 123 may implement a high pore density, as compared with the first separator 113.

In terms of ventilation rates, the second separator 123 may use a material or structure having improved ventilation rate by allowing the time when air of 100 ml passes the material or structure to be 300 seconds or less, based on the JIS evaluation method. In this case, the first separator 113 may use a material configured so that the air of 100 ml passes the material to be 500 seconds or less, based on the JIS evaluation method. In an embodiment, the amount of air passed by the material of the first separator 113 is less than the amount of air passed by the material of the second separator 123.

By way of summation and review, with the development of portable communication devices, the demand of secondary batteries employed in these communication devices has increased. Accordingly, consideration is given to improving reliability and the lifespan of secondary batteries.

As described above, embodiments may provide a secondary battery having an improved lifespan, and providing high power and high capacity. According to an embodiment, a secondary battery is provided, in which the porosity of the second separator is greater than that of the first separator, that may satisfy both high-capacity and high-power characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a first electrode assembly configured to include a first positive electrode plate, a first negative electrode plate, and a first separator interposed between the first positive electrode plate and the first negative electrode plate;
a second electrode assembly configured to include a second positive electrode plate, a second negative electrode plate, and a second separator interposed between the second positive electrode plate and the second negative electrode plate, the second separator having a porosity greater than that of the first separator, the first electrode assembly having high capacity, as compared with second electrode assembly, and the second electrode assembly having high power, as compared with the first electrode assembly; and
a case configured to accommodate the first and second electrode assemblies therein.

2. The secondary battery as claimed in claim 1, wherein the porosity of the second separator is 40% or more.

3. The secondary battery as claimed in claim 2, wherein the second separator includes polyurethane (PO) or a non-woven fiber mat.

4. The secondary battery as claimed in claim 3, wherein the first separator has a multi-layered structure.

5. The secondary battery as claimed in claim 4, wherein the first separator has a two-layer structure of polyethylene (PE)/polypropylene (PP).

6. The secondary battery as claimed in claim 4, wherein the first separator has a three-layer structure of PP/PE/PP or PE/PP/PE.

7. The secondary battery as claimed in claim 3, wherein the first separator includes a coating layer positioned on at least one surface thereof.

8. The secondary battery as claimed in claim 7, wherein the coating layer includes heat-resistant ceramic.

9. The secondary battery as claimed in claim 7, wherein the coating layer includes a polymer resin.

10. The secondary battery as claimed in claim 1, wherein the first separator has a tensile strength in a length direction thereof of 1500 kgf/cm² or more, and said tensile strength is greater than the tensile strength of the second separator in a length direction of the second separator.

11. The secondary battery as claimed in claim 1, wherein the first separator has a tensile strength in a width direction thereof of 1000 kgf/cm² or more, and said tensile strength is greater than the tensile strength of the second separator in a width direction of the second separator.

12. The secondary battery as claimed in claim 1, wherein the first separator has a perforation strength of 550 gf or more, and said perforation strength is greater than the perforation strength of the second separator.

13. The secondary battery as claimed in claim 1, wherein the first separator has a contraction ratio of 5% or less when the first separator is exposed at 120° C. for one hour, and said contraction ratio is less than the contraction ratio of the second separator when the second separator is exposed at 120° C. for one hour.

14. The secondary battery as claimed in claim 1, wherein the second separator has a ventilation rate such that 100 ml of air passes through the second separator in 300 seconds or less.

15. The secondary battery as claimed in claim 14, wherein:
the first separator has a ventilation rate such that 100 ml of air passes through the first separator in 500 seconds or less, and
the ventilation rate of the first separator is less than that of the second separator.

16. The secondary battery as claimed in claim 1, wherein the first and second electrode assemblies are connected in parallel to each other in the battery.

17. The secondary battery as claimed in claim 1, wherein the first and second electrode assemblies are accommodated in the case as separate windings.

18. A battery, comprising:
a sealed housing having first and second electrochemical cells therein, the first and second electrochemical cells being electrically connected in parallel and being impregnated with a same electrolyte, the first electrochemical cell having a discharge capacity in mAh that is greater than that of the second electrochemical cell when measured at a same C-rate, the first electrochemical cell including a first electrode, a second electrode, and a first separator, the first separator being between and in contact with the first and second electrodes, and the second electrochemical cell including a third electrode, a fourth electrode, and a second separator, the second separator being between and in contact with the third and fourth electrodes, the second separator having a porosity that is greater than that of the first separator.
